(19) United States
(12) Patent Application Publication
(10) Pub. No.: US 2007/0254077 A1
(43) Pub. Date: Nov. 1, 2007

(54) Extruded foodstuff and method of making

(76) Inventors: William J. Germano, Portland, OR (US); Bruce A. Bechtel, Corvallis, OR (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/413,295

(22) Filed: Apr. 28, 2006

(51) Int. Cl. A23L 1/00

(52) U.S. Cl. 426/516

(57) ABSTRACT

Method and apparatus for making an extruded foodstuff.

### BACKGROUND

There are a variety of edible products made by various processes including extrusion. For instance tortillas, candy, potato chips, pretzels, dog biscuits and fruit leathers all may be made by a preparation process involving extrusion. Food extrusion processes generally involve mixing a slurry of ingredients into a pastelike substrate and extruding the pastelike substrate into a desired shape, and then heating and flavoring the extruded product.

### BRIEF DESCRIPTION OF THE DRAWINGS

Non-limiting and non-exhaustive embodiments will be described with reference to the following figures, wherein like reference numerals refer to like parts throughout the various figures unless otherwise specified.

FIG. 1 illustrates a process for making an extruded foodstuff according to an embodiment.

FIG. 2 illustrates a process for making an extruded foodstuff according to an embodiment.

FIG. 3 illustrates a process for making an extruded foodstuff according to an embodiment.

FIG. 4 is a top view of a die according to an embodiment.

FIG. 5 is a top view of a die according to an embodiment.

FIG. 6 is a top view of a die according to an embodiment.

FIG. 7 is a cutaway view of a mixer according to an embodiment.

FIG. 8 is a side view of a hopper according to an embodiment.

FIG. 9 is a front view of dies and a proofing belt according to an embodiment.

FIG. 10 is a side view of a salter/seasoner according to a particular embodiment.

FIG. 11 is a side view of a die mold according to an embodiment.

FIG. 12 is a front view of a final product according to an embodiment.

### DETAILED DESCRIPTION

In the following detailed description, various embodiments will be disclosed. For purposes of explanation, specific numbers, materials, and/or configurations are set forth in order to provide a thorough understanding of the embodiments. However, it will also be apparent to one skilled in the art that the embodiments may be practiced without one or more of the specific details or with other approaches, materials, components, etc. In other instances, well-known structures, materials, and/or operations are not shown in detail and may be described only briefly to avoid obscuring embodiments. Accordingly, in some instances, features are omitted and/or simplified in order to not obscure the disclosed embodiments. Furthermore, it is to be understood that embodiments shown in the figures are illustrative representations and are not necessarily drawn to scale.

There are three methods of preparing extruded foodstuffs discussed in some detail in the following disclosure in particular embodiments. The methods discussed are; a method for mixing, extruding and baking a wheat-based foodstuff, a method for mixing, extruding and baking a com-based foodstuff and a method for mixing, extruding and baking a high nutrient content foodstuff. However, such discussion is meant to be illustrative and is not meant to be limiting in any regard with respect to claimed subject matter.

A number of shapes and varieties of extruded foodstuffs are discussed herein. However, the various shapes such as, for instance, an hourglass, triangle and a dog bone shape are merely illustrative. Also, many other shapes may be formed by an extrusion process such as, for instance, balls, circles, squares and/or tubes. Therefore, claimed subject matter is not limited to the embodiments discussed herein. Additionally, substrates, such as dough or masa, extruded during food processing are also versatile and may be made from a variety of ingredients. Such substrates may comprise a variety of end products of food processing such as, for instance, licorice, puffs, pretzels, candies, nutritional bars, and potato crisps, to name just a few, and claimed subject matter is not limited in this regard.

A number of terms may be used to describe a substrate that may be extruded into a particular shape in the following disclosure such as extrudate, dough, paste and/or masa. However, these are various industry terms used to describe a malleable substrate that may be extruded into a particular shape and claimed subject matter is not limited in this regard.

A manufacturing process for an extruded foodstuff, according to a particular embodiment, may comprise particular steps. First, ingredients may be mixed in large batches to make a substrate and fed to a hopper. Second, from a hopper a substrate may be gradually forced through an extrusion device by a variety of methods, such as, for instance, by air pressure, an auger or tapered screw. Such an extrusion device may be referred to as an “extruder.” An extruder may or may not add heat to a substrate. If an extruder adds such heat it may aid in a process of cooking the substrate. A substrate may be forced from an extruder through openings having a variety of diameters depending upon a desired end product, for example. The extruder may extrude a substrate (commonly called “extrudate” after extrusion) into lengths of extrudate that are then trimmed by a variety of methods to a final length. The strands of extrudate may have a variety of shapes as the strands exit the extruder such as, for instance, extrudate strands may be twisted, braided, ribboned and/or wrapped. In other instances, the substrate may be extruded into die molds that will give the extrudate a final shape. There are a large variety of shapes the die molds may give the extrudate. Extrudate that has been shaped by a die mold may be referred to as a “character.” For instance, a triangular tortilla chip, a round potato crisp, or a coin shaped chocolate may all be referred to as “characters.”

Third, after the extrudate leaves the extrusion device and is formed into lengths or characters it may fall or be placed on a conveyor belt. The extrudate may then be transported to a variety of stations throughout a food processing facility. For instance, the extrudate may be transported to a series of long ovens for baking and/or long kilns for drying and then moved through a seasoner where extrudate may be coated with seasoning. Rather than going to oven or kilns for baking or drying, the extrudate may be transported to a frying station where it may be fried in oil and then continuing on the conveyor belt the extrudate may be moved through a seasoner for a coating of seasoning. In other instances, the extrudate may need to be cooled immediately after it leaves the extruder in which case it may be moved through a refrigerated tunnel and then may be transported to other stations in the food processing facility such as to a glazer to receive a coating of glaze to prevent sticking together of the final products. After the extrudate is processed in the various stations of the food processing facility the extrudate is a finished food product and may be ready for packaging.

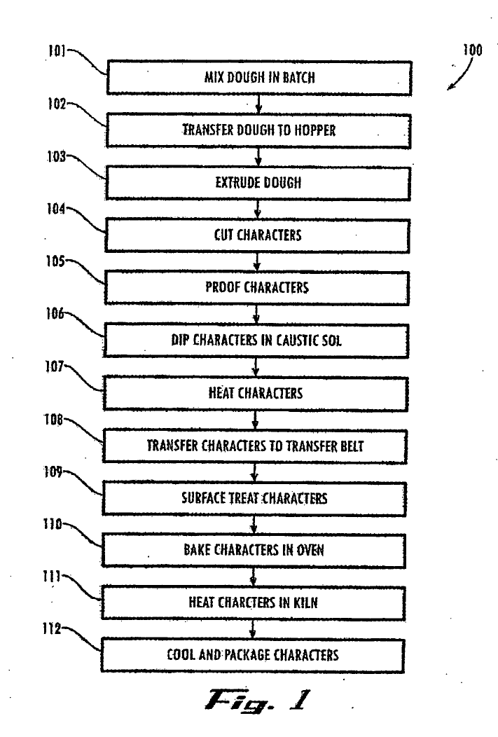

FIG. 1 illustrates a process 100 for making a wheat based foodstuff according to a particular embodiment. Referring to block 101, various ingredients may be blended, such as, for instance, wheat flour, salt, sugar, flavoring, yeast, leavening agents and shortening to make dough for a wheat based foodstuff. In a particular embodiment, ingredients for a pretzel chip may comprise; organic wheat flour, expeller pressed soybean oil, salt, vegetable fiber, evaporated cane juice, malt extract, soda, and yeast. These ingredients may be mixed together in the following proportions to make a particular embodiment of pretzel dough.

### EXAMPLE

| Ingredients: | Batch Lbs | % |
|---|---|---|
| Organic Flour | 300.000 | 92.75% |
| Soybean Oil | 8.000 | 2.47% |
| Salt-(I, M, R) I | 7.500 | 2.32% |
| Fiber | 3.500 | 1.08% |
| Evap Cane Juice | 3.000 | 0.93% |
| Malt | 0.600 | 0.19% |
| Sodium Bicarb | 0.600 | 0.19% |
| Yeast | 0.249 | 0.08% |
| TTL Raw Mat | 323.449 | 100.00% |

| | |
|---|---|
| Water | 137.000 |
| | 460.449 |

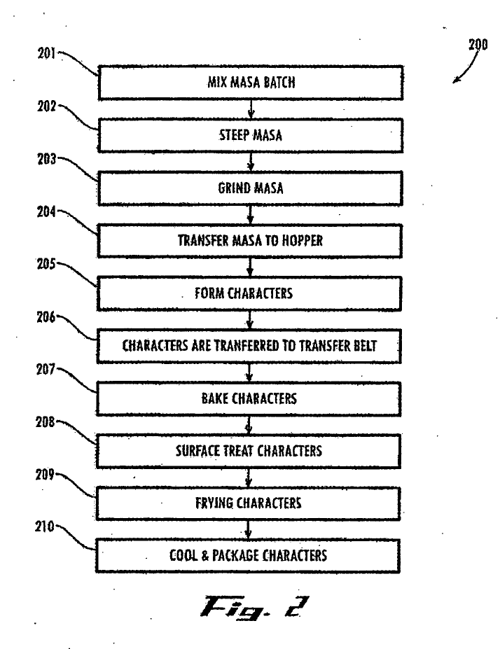

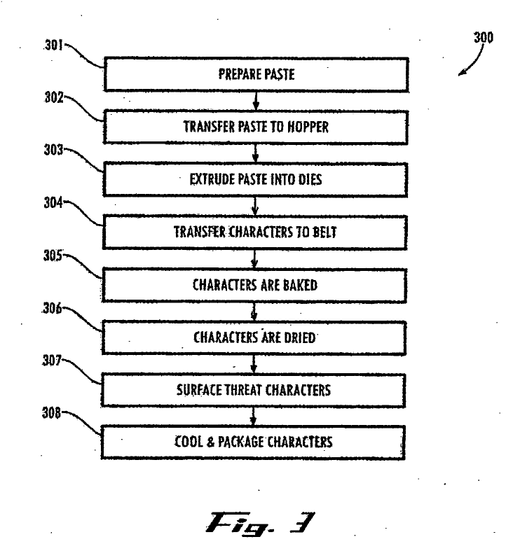

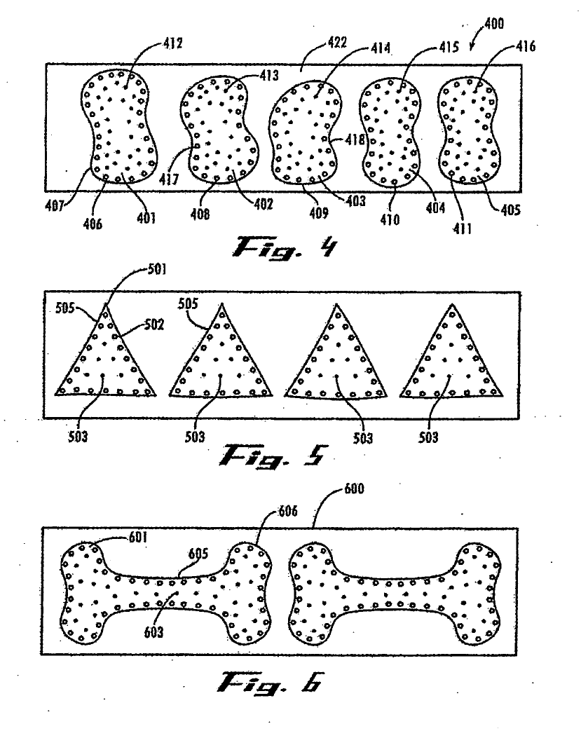

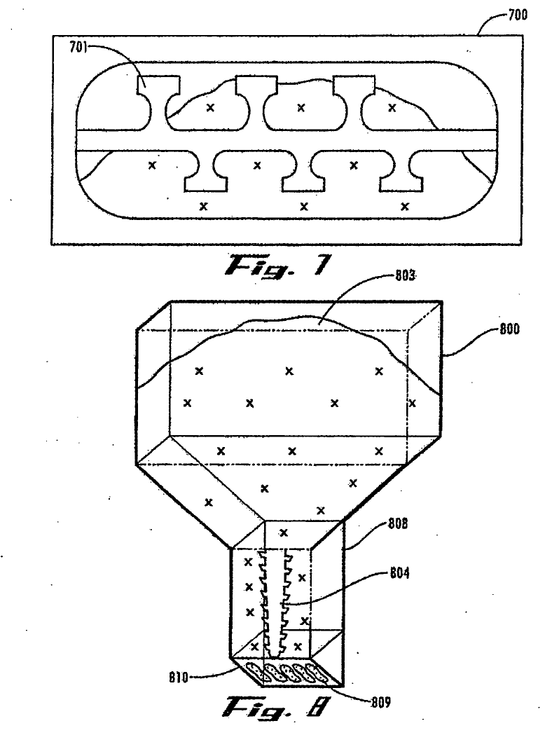

In a particular embodiment, although claimed subject matter is not limited in this respect, ingredients in the above example may be blended at block 101 using compounders 701 in large stainless steel mixers 700, illustrated in FIG. 7. However, these are merely examples of various types of ingredients, proportions of such ingredients, and methods of blending that may be used to make wheat based dough and claimed subject matter is not limited in this regard.

At block 102, dough may be transferred to one or more hoppers. In a particular embodiment, as illustrated in FIG. 8, hopper 800 may have a tapered shape 802 and an opening 801 on top for receiving dough 803. However, this is merely an example of the shape of a hopper and claimed subject matter is not limited in this regard.

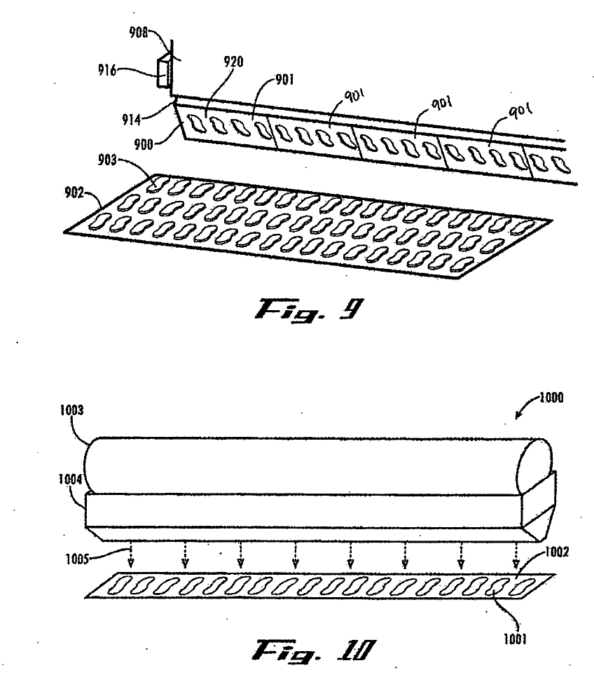

At block 103, dough may be fed from a hopper to an extrusion device. According to a particular embodiment, as illustrated in FIG. 8, dough 803 may be gravity fed from a hopper 800 into an extrusion device 808. Extrusion device 808 may comprise a worm screw 804 that may be capable of rotation to force dough 803 out of extrusion device 808, through head 810 and into die 809. In a particular embodiment, as illustrated in FIG. 9, a head 900 may comprise a wide, angled, metal duct, positioned between a line of dies 901 and a line of extrusion devices 908. According to a particular embodiment, extrudate may be forced out of extrusion devices 908, through head 900 and into dies 901. Head 900 may extend the entire length of a line of dies 901 and may be coupled to extrusion devices 908. A head 900 may provide a mounting (not shown) in which to seat dies 901. According to a particular embodiment, dies 901 may be secured to head 900 by a variety of methods, such as for instance by bolting, screwing and or welding. However, these are merely examples of methods of securing dies to a head and claimed subject matter is not limited in this regard.

Returning to FIG. 8, in a particular embodiment, dough 803 may be forced through numerous extrusion holes (illustrated in FIGS. 9, 10 and 11) of die 809. According to a particular embodiment, dough 803 may be continuously fed through head 810 to die 809. It should be understood, dough may be forced from a hopper and through an extrusion device in other embodiments using other techniques, such as, for instance, using air pressure, an auger and/or a tapered screw. However, these are merely examples of techniques to force dough from a hopper through an extrusion device and claimed subject matter is not limited in this manner.

FIG. 4, illustrates a particular embodiment of a die 400 having individual die molds 401-405 to shape characters according to die mold shapes. Such characters, in this context, may comprise shaped extrudate as described above and may be round, square, triangular or may resemble animals, cartoons, or a variety of other objects. In a particular embodiment, die molds may be designed to mimic the shape of a handmade Kettle™ brand Potato Chip. However, these are merely examples of die mold shapes and claimed subject matter is not limited in this regard.

In a particular embodiment, any number of dies 400 may be placed across a head (not shown). A die 400 may have five die molds. A die 400 may have a single shape represented or a variety of shapes. Additionally, in one particular embodiment, a die 400 may be about thirteen inches long by about four inches wide. However, this is merely an example of a way in which dies 400 may be provided for extruding a wheat based foodstuff and claimed subject matter is not limited in this regard.

In a particular embodiment, die molds may be designed to shape characters mimicking the shape of a handmade Kettle™ brand Potato Chip, as discussed above. The die molds designed to mimic the shape of a handmade Kettle™ brand Potato Chip may be irregularly shaped. In this context, irregularly shaped refers to a shape that may not be substantially symmetric about any axis as opposed to regularly shaped objects which may be symmetric about an axis. Additionally, according to a particular embodiment, a die mold may have a set number of metering holes 406 for extrusion of dough and be placed in a set location in a die mold 401. In a particular embodiment, the placement of metering holes 406 may enable a desirable distribution of dough within a die mold 401. Additionally, placement and number of metering holes 406 may enable desirable moisture transfer throughout a final product such that undesirable effects of moisture retention are avoided, such as, for instance, checking. Checking refers to hairline fractures in a final product that are not seen on inspection but that may cause cracking and breaking during handling, packaging and/or shipping.

In a particular embodiment, die mold 401 may have an irregular shape resembling an hourglass and may have thirty two metering holes 406 on a perimeter 407, die mold 402 may have an irregular offset “S” shape and may have thirty one metering holes 408 on a perimeter 417, and die mold 403 may have an irregular “C” shape and may have thirty two metering holes 409 on a perimeter 418.

The size and number of metering holes 406, 408, 409, 410 and 411 may be determined by a simulation based on a number of parameters such as, for instance, speed of extrusion, volume of die mold, surface to edge ratio and viscosity of dough. In a particular embodiment, such size and number of metering holes may be determined by trial and error, while, for example, varying one or more of these parameters. In a particular embodiment, variance of such parameters may be subject to constraints which may determine the degree to which such parameters may be reasonably varied. For instance, in a particular food processing facility oven length, baking times and baking temperatures may be factors that will affect or constrain a possible range of extrusion speeds. Additionally, physical constraints such as dimensions of die mountings on extrusion devices may affect the degree to which a parameter, such as, volume of a die mold may be varied. Alternatively, size and numbering of metering holes may be determined using CAD/CAM computer software tools and/or similar techniques. However, these are merely examples of methods of determining the size and number of metering holes for a particular application of extrusion of a wheat based foodstuff and claimed subject matter is not limited in this regard.

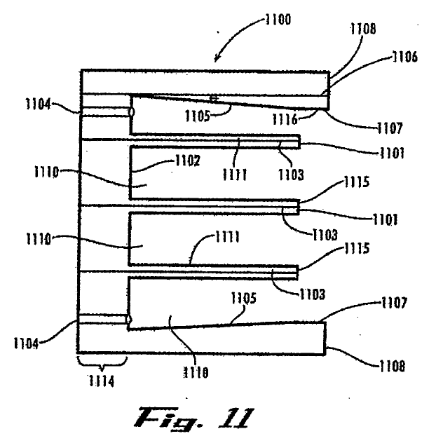

FIG. 11, shows a side view of a die mold 1100. In a particular embodiment, sidewalls 1105 may have an angle θ of at least 15° with respect to line 1106. In a particular embodiment, line 1106 may be in a plane perpendicular to inside bottom surface 1102. According to a particular embodiment, angling sidewalls 1105 in this way may enable conservation of surface area on a front face 422 of die 400, as shown in FIG. 4, without losing extrusion speed. Additionally, angling sidewalls 1105, illustrated in FIG. 11, may compress extrudate (not shown) and provide back pressure on metering holes 1104 enabling a more even distribution of dough within a die mold void 1110 during an extrusion process. Additionally, land 1107 may be at least ⅛ inch in length. According to a particular embodiment, providing a land 1107 near surface 1108 may provide a straight edge for shaping a final product. Without such a land 1107, extrudate may leave a die mold void 1110 without having taken a desired final form, such as, for instance, having a circumferential edge 1201, as illustrated in FIG. 12, substantially perpendicular to a front surface 1202 of a final product. Straight edges of land 1107 may define and hold the shape of a final product. However, these are merely examples of sidewall angles and die mold land dimensions and claimed subject matter is not limited in this regard.

Referring again to FIG. 4, in a particular embodiment, some metering holes 406, 408, 409, 410 and 411 may be placed along the periphery of die molds 401-405. Such placement of metering holes 406, 408, 409, 410 and 411 may enable controlling moisture transfer in a final product. Preventing or reducing moisture transfer may help prevent damage to a final product of an extrusion process. Damage from excess or displaced moisture in extruded foodstuffs may result in breakage and or hairline fractures weakening a final product. In a particular embodiment, metering holes 406 may be placed on a perimeter 407 and may be between 0.04 inches and 0.2 inches in diameter. In a particular embodiment, metering holes may be 0.1875 inches in diameter. However, these are merely examples of die molds and placement and sizes of metering holes, and claimed subject matter is not limited to the particular embodiment described.

In a particular embodiment, docking of dough may reduce or eliminate bubbling and blistering during baking. Blistering and bubbling may result from excess moisture and gas escaping from dough during baking. As dough heats up, the moisture or gas may escape or evaporate and create bubbles or blisters in a final product. Docking helps prevent bubbling and blistering by applying pressure to dough such that it is compressed in certain locations over the surface. This compression may leave impression marks 1204, as illustrated in FIG. 12, in the dough where it has been docked. During proofing or baking, docking may prevent dough from rising, bubbling or blistering in areas where dough has been docked. In a particular embodiment compressing members, such as, for instance, docking pins may be used to compress dough as it is extruded from a die mold. However, this is merely an example of compressing members and claimed subject matter is not so limited.

Referring again to FIG. 11, according to a particular embodiment, compressing members, such as, for instance, docking pins 1101 may be located on an inside bottom surface 1102 of a die mold 1100. Docking pins 1101 may comprise elongated cylinders which may be either hollow or solid. Additionally, docking pins 1101 may be fixed in place or may be capable of extending and retracting substantially along longitudinal axis 1103. However, these are merely examples of compressing member shapes and placement and claimed subject matter is not limited in this regard. In a particular embodiment, docking pins 1101, if hollow, may be capable of extruding dough through lumen 1111 along longitudinal axis 1103. In another particular embodiment, docking pins 1101, if solid, may be adjacent metering holes 1104 capable of extruding dough around docking pins 1101.

According to a particular embodiment, compressing members such as, for instance, docking pins 1101 may be substantially stationary and fixed to inside bottom surface 1102. In another embodiment, docking pins 1101 may be capable of a piston like action and may be slidably coupled to bores (not shown) embedded in an inside bottom portion 1114 of die 1100. However, these are merely examples of various types, configurations and capabilities of compressing members such as docking pins and claimed subject matter is not limited in this regard. According to a particular embodiment, docking pins 1101 may move substantially along longitudinal axis 1103 in response to mechanical, pneumatic and/or hydraulic force. However, these are merely examples of various forces that may act on compressing members such as docking pins capable of moving and claimed subject matter is not limited in this regard.

Compressing members such as, docking pins 1101 may be capable of compressing extruded dough. As discussed above, such compression may prevent certain portions of the extruded dough from rising, bubbling or blistering. Stationary docking pins 1101 may compress extruded dough. According to a particular embodiment, as dough is extruded through metering holes 1104, dough may be pushed against docking pins in response to back pressure from a number of sources. In a particular embodiment, dough being extruded from metering holes 1104 may be under constant pressure from an extrusion device, as described above, and may extrude dough continuously. Angled sidewalls 1105 may provide a source of back pressure which may force dough against tips 1115 of docking pins 1101 because of the relative position of tips 1115 just below frustrum 1116 of angles sidewall 1105. This position may allow docking pins 1101 to compress dough as it is filling in die mold void 1110. Additionally, mechanical knife 914, illustrated in FIG. 9, may provide another source of back pressure as it is slicing through characters 903. A knife 914 may operate mechanically and may be mounted in a guide arm 916 that is on a cam (not shown) that allows it to cut down across the dies 901. The knife 914 may then return to the top of the dies 901 enabling the knife 914 to repeat the process of cutting characters 903 as they are continuously extruded from dies 901. According to a particular embodiment, as knife 914 moves across the face 920 of dies 901, it may provide a surface against which extruding dough may compress. As the dough compresses against mechanical knife 914, it may also compress against docking pins 1101, illustrated in FIG. 11, achieving a docking effect. However, this is merely an example of a way in which compressing members such as, docking pins may compress dough during an extrusion process and claimed subject matter is not limited in this regard.

According to another embodiment, docking pins 1101, if capable of longitudinal motion, may compress dough in a way similar to that described above and/or may actively compress dough as dough is being cut with mechanical knife 914. Docking pins 1101 may move in response to a mechanical, pneumatic and/or hydraulic force pressing dough against mechanical knife 914, shown in FIG. 9. However, this is merely an example of a way in which compressing members such as, docking pins may compress dough during an extrusion process and claimed subject matter is not limited in this regard.

Compressing extruded dough by docking may prevent blistering and bubbling in undesirable areas of a character 903. Blistering may be desirable in certain locations such as at the edges of a final product and docking pins 1101 may be positioned accordingly. For instance, in a particular embodiment, compressing members such as, docking pins 1101 may be substantially centrally located in order to induce blistering only on the edges of a final product. Referring now to FIG. 4, in a particular embodiment, there may be 24 docking pins that may be centrally located within die molds 401-405. However, this is merely an example of numbers and placement of compressing members such as, docking pins and claimed subject matter is not limited in this regard.

By docking extrudate against a blade of knife 914 during a cutting action, as illustrated above, a process for making extruded foodstuffs may avoid an additional step of docking extrudate after being cut and/or removed from an extruder. According to an embodiment, this may be enabled, at least in part, by placement of docking pins 1101 in an interior region of die mold 1100. Additionally, as illustrated above, placement of metering at the periphery of a die mold and surrounding docking pins may also enable controlling of moisture transfer in a final product.

At block 104, characters are cut from extruding dough. As shown in FIG. 9, in a particular embodiment, characters 903 may be cut with a knife 914, similar to a hacksaw blade and may fall onto a proofing belt 902. At block 105, characters 903 may move from a die cutting station to another area of a food processing facility on a conveyor belt. After being cut away from a die 901, characters may go through a proofing (rising) phase for a period of time, such as, for instance, 135 seconds. While characters are proofing a conveyor belt may be referred to as a proofing belt. These are merely examples of ways in which characters may be extracted from dies and proofed. For instance, there are many varieties of proofing times depending on the dough recipe and the desired end product and claimed subject matter is not limited to the particular embodiment described.

After characters have been proofed, in a particular embodiment, they may be transferred to a caustic solution, at block 106. In a particular embodiment, characters may be immersed in a caustic solution. A caustic solution may comprise a variety of compounds such as, for instance, hydrogen peroxide, sodium hydroxide, sodium carbonate or lye. In a particular embodiment, dipping characters in a caustic solution may provide a particular taste sensation to a final product, protect against microbial spoilage, affect coloring of final product and may enable seasoning to adhere to the surface of characters. The caustic solution may have a ph of about 0.7. However, these are merely examples of compounds and ph values that may comprise a caustic solution and claimed subject matter is not limited in this regard.

At block 107, in a particular embodiment, characters may be heated in the above described caustic solution up to a temperature of about 195° F. Additionally, characters may travel on a conveyor belt through a caustic solution for a set amount of time, such as, 10-30 seconds, for example. At block 108, characters may be removed from a caustic solution by a transfer mechanism, such as, for instance, a transfer belt. Upon removal from a caustic solution excess moisture may be remove from characters by a variety of methods including blowing moisture off of characters by exposing characters to a pressurized air stream. However, these are merely examples of methods of exposing characters to a caustic solution and claimed subject matter is not limited in this regard.

At block 109, characters may be surface treated with a variety of substances, such as, for instance, dry salt or liquid salt solution, oil, liquid seasoning, various nutrients, and/or various dry seasonings. However, these are merely examples of varieties of surface treatments that may be applied to characters and claimed subject matter is not limited in this regard.

FIG. 10, depicts a particular embodiment of surface treatment, as described at block 109 in FIG. 1, that may be applied to a character. A salter 1000 is depicted. In a particular embodiment, salter 1000 may be used to apply a surface treatment to characters 1001 as they travel on a transfer belt 1002. A cylinder 1003 may rotate in the clockwise or counterclockwise direction above a funnel shaped hopper 1004 and may uniformly distribute dry salt out of hopper 1004. A surface treatment, salt 1005, may then be applied to characters 1001. In another embodiment, salt or any variety of surface treatment may be applied to characters 1001 in a liquid form using a spraying type device (not shown). Alternatively, surface treatment may be applied to characters 1001 by hand. However, these are merely examples of methods and devices for applying a surface treatment to characters 1001 and claimed subject matter is not limited in this regard.

At block 110, characters may continue to travel on a transfer belt through an oven. In a particular embodiment, characters may be heated to different temperatures in respective zones as they travel at a set speed, such as, for example, 20 feet per minute on the transfer belt. The characters may first be heated to about 580 degrees F. in a first zone, characters may next be heated to about 575 degrees F. in a second zone and characters may be heated to about 545 degrees F. in a third zone. However, this is merely an example of a method of heating characters in an oven during processing and claimed subject matter is not limited in this respect.

At block 111, characters may travel, on a transfer belt, through a kiln oven. In a particular embodiment, characters may be heated to multiple temperatures in respective zones as they travel on a transfer belt at a set speed, such as, 3 feet per minute, for instance. According to a particular embodiment, fine tuning of a final product may occur as characters travel through a kiln oven. Such fine tuning may involve minor adjustments to kiln temperatures in various zones. Additionally, the speed at which the characters move through the kilns may be adjusted. For instance, a first zone may be heated to about 240° F. and the travel speed may be set to 4 feet per minute in order to decrease moisture levels in characters and to start the baking process. A second zone may be heated to about 245° F. and travel speed may be set to 2 feet per minute in order to complete the baking process and to continue to remove moisture from the characters. Also, a third zone may be heated to about 250° F. and travel speed may be set to 3 feet per minute in order to increase color of the product and continue to remove moisture from the characters However, this is merely an example of a method of heating characters in a kiln oven during processing and claimed subject matter is not limited in this respect.

At block 112, after characters have been processed to a final product they may be cooled and packaged for delivery.

FIG. 2 illustrates a process 200 of making a corn based foodstuff according to a particular embodiment. At block 201, starts process 200 by blending various ingredients to mix masa (an industry term for corn based dough) for a corn based foodstuff. Various ingredients may be used to make masa such as, for instance, yellow corn, white corn, flour, whole wheat, blue cornmeal, lime, water, oil, salt and/or various seasonings. However, these are merely examples of various types of ingredients that may be used to make a corn based masa and claimed subject matter is not limited in this regard.

At block 202 the masa mixture may be steeped in a batch cooker or other variety of cooker such as, for instance, a closed cooker or Hamilton steam cooker. Heat and/or pressure may be applied enabling water to be absorbed into the masa mixture. However, these are merely examples of ways in which masa may be steeped and claimed subject matter is not be limited in this regard.

At block 203, masa may be transferred to a conveyor belt for transport to a grinder. Masa may be ground between rotating grinding stones rotating at various speeds, such as, for instance, 500-700 rpm. Grinding masa may enable reduction in masa particle size, and increasing plastic and cohesive properties of masa facilitating extrusion and shaping in dies. However, this is merely an example of a method of grinding masa and claimed subject matter is not limited in this regard.

At block 204 the masa may be transferred to at least one hopper. In a particular embodiment, more than one hopper may be used. From one or more hoppers, masa dough may be forced through an extrusion device into character shaping dies. As described above, there are a number of methods of forcing masa from a hopper to an extrusion device, such as for instance using air pressure and/or a worm screw, as illustrated in FIG. 8. However, these are merely examples of ways in which masa may be forced into an extrusion device and claimed subject matter is not limited in this manner.

In FIG. 2, at block 205 masa may be extruded into shaping dies. For example as illustrated in FIG., according to a particular embodiment, a die 500 may have die molds 501 for shaping characters (not shown). In a particular embodiment, the die molds may be triangular and capable of receiving masa during an extrusion process. A die 500 may have four die molds 501. Also, a die 500 may have a single shape represented or a variety of shapes. However, this is merely an example of a way in which a die for extruding a corn based foodstuff may be configured and claimed subject matter is not limited in this regard.

A die mold 501 may have a set number of metering holes 502 for extrusion of masa. Metering holes 502 may be placed in associated set locations on a die mold 501. In a particular embodiment, die mold 501 may have a triangular shape and may have twenty one metering holes 502 placed on a perimeter 505 of a die mold 501. The size and number of metering holes 501 may be determined as discussed above with reference to FIG. 4, In a particular embodiment, metering holes 502 may be placed along the periphery of die mold 501. As discussed above, such placement of metering holes 502 may enable controlling moisture transfer in a final product. Again, however, these are merely examples of die molds and placement of metering holes for extrusion of masa and claimed subject matter is not limited to the particular embodiment described.

Referring still to FIG. 5, docking pins 503 may comprise elongated cylinders and may be either hollow or solid. However, these are merely examples of docking pin shapes and claimed subject matter is not limited in this regard. In a particular embodiment, docking pins 503, if hollow, may be capable of extruding masa through a longitudinal axis (not shown). In another particular embodiment, docking pins 503, if solid, may comprise adjacent extrusion members (not shown) capable of extruding masa around docking pins 503. Docking pins 503 may be capable of compressing extruded dough such that, for instance, during a baking or frying phase certain portions of the extruded masa may blister while other portions remain compressed. Compressing extruded masa in this way may prevent blistering in undesirable areas of a character (not shown). In a particular embodiment, there may be ten docking pins per die mold 501. However, these are merely examples of numbers and placement of docking pins 503 and claimed subject matter is not limited in this regard.

At block 206, in a particular embodiment, characters may be extracted from dies and deposited onto a transfer belt. At block 207, characters may travel through and be heated in an oven. In a particular embodiment, characters may travel on a transfer belt to a baking station where they may be baked at temperatures ranging from 500° to 555° F. in a multi-tiered oven. According to a particular embodiment, characters may travel through a tiered oven on a transfer belt and remain in each tier for up to 50 seconds. In another embodiment, a lower fat content final product may be produced by slowly baking characters. Baking time may be dependant upon the variety of ingredients used. In a particular embodiment, characters may then be transferred from a multi-tiered oven on a transfer belt and cooled, for instance, by moving on the transfer belt through a series of cooling racks. In addition to placement of metering holes and use of docking pins, cooling may also enable a reduction in moisture content of characters and a reduction in blistering or bubbling during frying.

At block 208 characters may be fried in oil. Oil used for frying may have temperatures ranging from 330° to 375° F. In a particular embodiment, frying may take between 40-90 seconds. According to a particular embodiment, frying time and temperature may be dependant upon the variety of ingredients used. However, this is merely an example of a method of frying characters formed from extruded masa and claimed subject matter is not limited in this regard. At block 209, characters may be surface treated with a variety of substances such as salt, flavoring, seasoning, sugar, and/or various liquid solutions such as oil. However, this is merely an example of a method of baking and/or frying and surface treating characters during processing and claimed subject matter is not limited in this respect. Finally, at block 210, in FIG. 2, characters may be cooled and packaged.

FIG. 3, illustrates a process 300 of making a fortified foodstuff according to a particular embodiment. Block 301 may blend various ingredients to develop a viscous paste. A wide variety of ingredients may be used to make a paste such as, for instance, corn, wheat, rice, milk, eggs, poultry, liver, beef, fats and oils, and fiber. The dry ingredients are typically mixed with enough water to bring the moisture content up to 30%. The paste is then heated in a conditioner chamber where other moist ingredients may be added. However, these are merely examples of various types of ingredients and methods of blending that may be used to make a fortified paste and claimed subject matter is not limited in this regard.

At block 302 the viscous paste may be transferred to an extruder. In a particular embodiment, the extruder may have more than one hopper. From the hopper or hoppers the paste is forced into the extrusion device and into character shaping dies. As described above, there are a number of methods of forcing a viscous paste from a hopper to an extrusion device, such as for instance using air pressure and/or a tapered screw (as illustrated in FIG. 8). Heat may be generated during the extrusion process and may warm the viscous paste. However, these are merely examples of ways in which a viscous paste may be forced into an extrusion device and claimed subject matter is not limited in this manner.

In FIG. 3, at block 303 a paste may be extruded into shaping dies. As shown in FIG. 6, according to a particular embodiment, block 303 may extrude a paste through a die 600 into a die mold 601. In a particular embodiment, the die molds 601 may be dog bone shaped and capable of receiving a viscous paste during an extrusion process. A die 600 may have 2 die molds 601. Also, a die 600 may have a single shape represented or a variety of shapes. However, this is merely an example of a way in which a die mold 601 for extruding a fortified foodstuff may be shaped and claimed subject matter is not limited in this regard.

A die mold 601 may have a set number of metering holes 602 for extrusion of a viscous paste and metering holes 602 may be placed in a particular location on a die mold 601. In a particular embodiment, die mold 601 may be dog bone shaped and may have between fifty and seventy metering holes 602 on a perimeter 605 of a die mold 601. The size and number of metering holes 601 may be determined as discussed above with reference to FIG.4. According to a particular embodiment, placement of metering holes on a perimeter 606 may enable controlling and/or reducing moisture transfer. However, these are merely examples of die molds and placement of metering holes therein and claimed subject matter is not limited to the particular embodiment described.

As discussed above, docking pins 603 may be be placed substantially centrally in a die mold 601. In a particular embodiment, docking pins 603 may be capable of compressing extruded paste such that, for instance, during a baking phase certain portions of the extruded viscous paste may blister or rise while other portions remain compressed. This may reduce unwanted blistering or bubbling of an extruded character (not shown). Additionally, compression of extruded paste may aid in transfer of moisture out of characters (not shown) during a drying phase. In a particular embodiment, there may be thirty to forty docking pins per die mold 601. However, these are merely examples of numbers and placement of docking pins in a die mold and claimed subject matter is not limited in this regard.

At block 304, in a particular embodiment, characters may be extracted from dies and deposited onto a transfer belt. Characters may travel on -a transfer belt where they may be transferred to a tunnel baking oven. At block 305, characters may travel through and be heated in a tunnel baking oven. At block 306 characters may be dried to significantly reduce moisture content. At block 307 characters may be surface treated with a variety of substances such as salt, flavoring seasoning, sugar, vitamins and/or various liquid solutions such as oil. However, this is merely an example of a method of baking, drying and surface treating characters during processing and claimed subject matter is not limited in this respect. Finally, at block 309, in FIG. 3, characters may be cooled and packaged.

While certain examples of claimed subject matter have been illustrated herein, many modifications, substitutions, changes and equivalents may occur without deviating from claimed subject matter. It is, therefore, to be understood that the appended claims are intended to cover such modifications, substitutions, changes and equivalents.

What is claimed is:

1. A method of making an extruded foodstuff comprising:
extruding a substrate through a die mold having metering holes located on a perimeter of said die mold, and compressing members located on said die mold, to form a character from said substrate;
compressing said substrate against said compressing members while said substrate is in said die mold, to dock said character being formed; and
removing said character from said die mold after said compressing said substrate in said die mold.

2. The method of claim 1, wherein said removing said character comprises cutting said character from said die mold with a knife.

3. The method of claim 2, wherein said compressing said substrate further comprises;
placing a blade of a knife across an opening of said die mold following removal of a previous character; and
compressing said substrate against said blade while compressing said substrate against said compressing members.

4. The method of claim 1, and further comprising immersing said character in a solution.

5. The method of claim 1, and further comprising exposing said character to compressed air to remove moisture.

6. The method of claim 1, and further comprising baking said character.

7. The method of claim 1, wherein said substrate further comprises a wheat based foodstuff.

8. The method of claim 1, wherein said substrate further comprises a corn based foodstuff.

9. The method of claim 1, wherein said substrate further comprises a protein based foodstuff.

10. The method of claim 1, wherein said extruding said substrate into said die mold further comprises extruding said substrate through at least one compressing member.

11. The method of claim 1, wherein said extruding said substrate into said die mold further comprises extruding said substrate adjacent to at least one compressing member.

12. The method of claim 1, wherein said extruding said substrate into a die mold further comprises extruding said substrate through at least one metering hole.

13. The method of claim 1, wherein said compressing member comprises a docking pin.

14. The method of claim 1, wherein said compressing said substrate further comprises extending said compressing members.

15. The method of claim 4, wherein said immersing said character in a solution further comprises retaining at least one character in said solution wherein said solution is heated to about 195° F.

16. The method of claim 4, wherein said solution comprises of at least one compound selected from the group consisting of NaOH, H₂O₂, NaCO₃ and/or Lye.

17. The method of claim 6, wherein baking said character further comprises exposing said character to at least three temperature zones.

18. The method of claim 1, wherein said character is substantially in the shape of an irregular “S.”

19. The method of claim 1, wherein said character is substantially in the shape of an irregular “C.”

20. The method of claim 1, wherein said character is substantially in the shape of an irregular hourglass.

21. The method of claim 1, wherein said character is substantially in the shape of a dog bone.

22. The method of claim 1, wherein said character is substantially in the shape of a triangle.

23. An apparatus comprising:
a die have at least one die mold;
said die mold having an inside bottom surface and adjacent sidewalls;
first metering holes distributed about a perimeter of said die mold inside bottom surface; and
compressing members distributed about said die mold inside bottom surface.

24. The apparatus of claim 23, wherein said sidewalls are angled inward with respect to said inside bottom surface.

25. The apparatus of claim 24, wherein said angle is at least fifteen degrees from a plane perpendicular to said inside bottom surface.

26. The apparatus of claim 24, wherein said sidewalls further comprise at least a ⅛ inch land.

27. The apparatus of claim 23, wherein said first metering holes are at least 0.1875 inches in diameter.

28. The apparatus of claim 23, wherein said docking pins further comprise second metering holes.

29. The apparatus of claim 28, wherein said second metering holes are at least 0.1875 inches in diameter.

30. The apparatus of claim 23, wherein said compressing members are capable of extending and retracting substantially in a direction perpendicular to said inside bottom surface.

31. The apparatus of claim 30, wherein said compressing members move in response to a mechanical force.

32. The apparatus of claim 30, wherein said compressing members move in response to a hydraulic force.

33. The apparatus of claim 30, wherein said compressing members move in response to a pneumatic force.

34. The apparatus of claim 23, wherein said compressing members are slidably coupled to an inside bottom portion of said die mold.

35. The apparatus of claim 18 wherein said compressing members are docking pins.
